(19) United States
(12) Patent Application Publication
(10) Pub. No.: US 2019/0126247 A1
(43) Pub. Date: May 2, 2019

(54) CORE/SHELL HYDROCARBON TRAP CATALYST AND METHOD OF MANUFACTURE

(71) Applicant: BASF Corporation, Florham Park, NJ (US)

(72) Inventor: Michel Deeba, East Brunswick, NJ (US)

(21) Appl. No.: 16/083,335

(22) PCT Filed: Mar. 6, 2017
(86) PCT No.: PCT/IB2017/051298

§ 371 Date: Sep. 7, 2018

Related U.S. Application Data
(60) Provisional application No. 62/305,659, filed on Mar. 9, 2016.

(51) Int. Cl. B01J 23/46; B01J 21/04; B01J 29/70; B01J 29/40; B01J 29/80; B01J 35/02; B01J 35/04; B01J 35/00; B01J 37/02; B01D 53/94; F01N 3/28; F01N 3/10

(52) U.S. Cl. CPC B01J 23/46; B01J 29/061; B01J 29/7007; B01J 29/40; B01J 29/80; B01J 35/026; B01J 35/04; B01J 35/0006; B01J 35/0013; B01J 37/0244; B01J 37/0221; B01J 37/0228; B01J 37/0236; B01D 53/944; B01D 53/945; F01N 3/2832; F01N 3/101; B01J 21/04

(57) ABSTRACT

The invention provides an automotive catalyst composite that includes a catalytic material on a carrier, the catalytic material including a plurality of core-shell support particles including a core and a shell surrounding the core, wherein the core includes a plurality of particles having a primary particle size distribution d₉₀ of up to about 5 μm, wherein the core particles include particles of one or more molecular sieves and optionally particles of one or more refractory metal oxides; and wherein the shell comprises nanoparticles of one or more refractory metal oxides, wherein the nanoparticles have a primary particle size distribution d₉₀ in the range of about 5 nm to about 1000 nm (1 μm); and optionally, one or more platinum group metals (PGMs) on the core-shell support. The invention also provides an exhaust gas treatment system and related method of treating exhaust gas utilizing the catalyst composite.

### FIELD OF THE INVENTION

The present invention relates to catalyst for coating on monolithic substrates for emission treatment systems and methods of making such catalysts. Also provided are methods for reducing contaminants in exhaust gas streams, such as methods for treating exhaust hydrocarbon emissions from automotive engines, such as gasoline, diesel, or lean burn gasoline engines.

### BACKGROUND OF THE INVENTION

Significant reduction in tail pipe hydrocarbon emission is necessary to meet stringent emission regulations. Oxidation catalysts comprising a platinum group metal (PGM) dispersed on a refractory metal oxide support are known for use in treating the exhaust of gasoline or diesel engines in order to convert both hydrocarbon and carbon monoxide gaseous pollutants by catalyzing the oxidation of these pollutants to carbon dioxide and water. Such catalysts are generally adhered to ceramic or metallic substrate carriers, which are placed in the exhaust flow path from an internal combustion engine to treat the exhaust before it vents to the atmosphere.

Catalysts used to treat the exhaust of internal combustion engines are less effective during periods of relatively low temperature operation, such as the initial cold-start period of engine operation, because the engine exhaust is not at a temperature sufficiently high for efficient catalytic conversion to occur. Accordingly, reducing hydrocarbon emission during the cold-start period (typically the first few seconds after engine startup) will have great impact on reducing tail pipe emission. To this end, an adsorbent material referred to as a “hydrocarbon trap” can be provided as part of a catalytic treatment system in order to adsorb gaseous pollutants, usually hydrocarbons, and retain them during the initial cold-start period. For example, some molecular sieve materials, such as beta zeolite, are known to absorb hydrocarbons at low temperatures during engine startup.

However, molecular sieve materials (e.g., zeolites) incorporated as a component within the catalyst composition are known to poison the PGM component after high temperature aging, resulting in reducing effectiveness of the catalyst material and thus higher tail pipe emission. The accepted reason for this deactivation mode is due to Si—O migration from the molecular sieve to the PGM component. This migration is known to occur during exposure of the catalyst to high temperature aging observed during certain driving cycles.

U.S. Pat. No. 9,120,077 is directed to surface-coated zeolite materials for diesel oxidation applications. Beta-zeolite material surface coated with at least one of zirconia and alumina is provided to both shield the negative interaction between zeolite and the platinum group metal and to increase washcoat porosity by agglomerating small zeolite particles via binding zirconia or alumina. The surface-coated zeolite materials may be prepared via either incipient wetness impregnation of zeolite or by spray-drying mixed zeolite slurry. Spray-dried materials include particles as broken spheres, which leads to higher washcoat porosity.

U.S. Patent Appl. Pub. No. 2014/0170043 is directed to catalytic articles that include a washcoat of platinum group metal on refractory oxide support particles, and further including a molecular sieve wherein greater than 90% of the molecular sieve particles have a particle size greater than 1 μm.

U.S. Pat. No. 6,632,768 is directed to an adsorbent for hydrocarbons in exhaust gas, the adsorbent being an agglomerate of double-structure particles, each of which includes a zeolite core and a ceramic coat wrapping the zeolite core and having a plurality of through-pores communicating with a plurality of pores in the zeolite core. A starting material for the adsorbent is a liquid mixture of an agglomerate of zeolite particles and a ceramic coat-forming precursor solution. Exemplary processes for producing the adsorbent are a flame synthesis method and a spray pyrolysis method.

U.S. Pat. No. 7,670,679 is directed to core-shell ceramic particulates comprising a core particulate structure comprising a plurality of primary particulates and a plurality of primary pores; and a shell at least partially enclosing the core particulate structure. The core comprises a ceramic material such as an oxide, a nitride, a carbide, a boride, or a chalcogenide. The shell may comprise a ceramic material such as an oxide, a nitride, a carbide, a boride, or a chalcogenide or a catalytic material such as transition metals and their oxides. An in-situ process includes mixing a dispersion of core particulate structure and a solution comprising shell material precursor to dispose shell particulates onto the core. An ex-situ process includes disposing shell material onto the core particulate structure either by a dry or a wet chemical means, and the shell material may be disposed either by mechanical or by chemical means.

U.S. Pat. No. 9,101,915 is directed to catalyst particles comprising a layered core-shell-shell structure having a base metal core, a precious metal outer shell, and an intermediate layer comprising a base metal/precious metal alloy between the core and the outer shell.

U.S. Pat. No. 8,911,697 is directed to a catalytically active material for reacting nitrogen oxides with ammonia in the presence of hydrocarbons. The material consists of an inner core made of a zeolite exchanged with one or more transition metals or a zeolite-like compound exchanged with one or more transition metals, the core of the catalytically active material is encased by a shell, which is made of one or more oxides selected from silicon dioxide, germanium dioxide, aluminum oxide, titanium oxide, tin oxide, cerium oxide, zirconium dioxide, and mixed oxides thereof. Individual zeolite particles are impregnated with a solution comprising one or more soluble precursors of the oxides which are to form the shell.

There is a continuing need to provide gasoline and diesel engine catalysts that are effective to reduce emissions from light, medium, and heavy duty applications, and whose ingredients (such as molecular sieves and platinum group metals) are used efficiently while ensuring stability and cost-effectiveness. In particular, there is a need in the art to develop new methods or approaches for neutralizing Si—O vapor migration before reaching the active components in as catalyst article, mainly PGM components.

### SUMMARY OF THE INVENTION

In one aspect, the invention provides an automotive catalyst composite comprising a catalytic material on a carrier, the catalytic material comprising a plurality of core-shell support particles comprising a core and a shell surrounding the core. The core typically comprises a plurality of particles having a primary particle size distribution d₉₀ of up to about 5 μm, wherein the core particles comprise particles of one or more molecular sieves and optionally particles of one or more refractory metal oxides. The shell typically comprises nanoparticles of one or more refractory metal oxides, wherein the nanoparticles have a primary particle size distribution d₉₀ in the range of about 5 nm to about 1000 nm (1 μm). Optionally, one or more platinum group metals (PGMs) are impregnated on the core-shell support. The catalytic material is effective to temporarily trap hydrocarbons in a vehicle exhaust stream and thereafter release the trapped hydrocarbons and convert the hydrocarbons to carbon oxides and water. The core-shell support particles are porous, and in certain embodiments, have an average pore radius greater than about 30 Å as measured by N₂ porosimetry. The automotive catalyst composite can be zoned with a different catalytic material along a length of the carrier or layered with a different catalytic material on the carrier.

In certain embodiments, the shell has a thickness in the range of about 1 to about 10 μm. For example, the shell can have a thickness in the range of about 2 to about 6 μm. In one embodiment, the shell has a thickness of about 10 to about 50% of an average particle diameter of the core-shell support. The core of the particles has an exemplary diameter in the range of about 5 to about 20 μm, such as about 5 to about 15 μm. Typically, the core-shell support comprises about 50 to about 95% by weight of the core and about 5 to about 50% by weight of the shell, based on the total weight of the core-shell support. For the overall core-sell support, the average particle diameter is typically in the range of about 8 μm to about 30 μm.

In certain embodiments, the core comprises particles of the molecular sieve have a primary particle size distribution d₉₀ in the range of about 0.1 to about 5 μm. The core may optionally comprise at least two molecular sieve types selected from the group consisting of small pore molecular sieve type, medium pore molecular sieve type, and large pore molecular sieve type.

The refractory metal oxide of the shell can be, for example, alumina, zirconia-alumina, ceria, ceria-zirconia, zirconia, titania, silica, silica-alumina, manganese oxide, or a combination thereof. The shell can also include a base metal oxide, such as lanthana, baria, strontium oxide, calcium oxide, magnesium oxide, or a combination thereof. When present, the base metal oxide is typically used in an amount of about 1 to about 20% by weight, based on the weight of the core-shell support particles, more typically about 5 to about 10% by weight.

The molecular sieve of the core can vary, with exemplary materials including zeolitic and zeotype materials such as chabazite, ferrierite, clinoptilolite, silico-alumino-phosphate (SAPO), beta-zeolite, Y-zeolite, mordenite, ZSM-5, and combinations thereof. The molecular sieve is advantageously ion-exchanged with a metal, such as a metal selected from La, Ba, Sr, Mg, Pt, Pd, Ag, Cu Ni, Co, Fe, Zn, and combinations thereof.

In certain embodiments, one or more PGMs is impregnated on the shell, the PGMs being selected from the group consisting of platinum (Pt), rhodium (Rh), palladium (Pd), iridium (Ir), ruthenium (Ru), and combinations thereof. Advantageously, the PGM comprises a Pt component, a Pd component, or combinations thereof. For example, the weight ratio of Pt to Pd can be in the range of about 5:1 to about 1:5. The total amount of Pt and Pd is typically about 0.1 to about 5% by weight, based on the total weight of the core-shell support.

The carrier can be selected from various carriers known in the art, such as a flow-through substrate or a wall-flow filter. A typically loading of the core-shell support particles on the carrier is about 0.5 to about 2.5 g/in³. The automotive catalyst composite can include further components, such as a refractory metal oxide binder (e.g., alumina, zirconia, or a mixture thereof), a separate metal oxide component mixed with the core-shell support particles and optionally impregnated with a PGM, or separate mesoporous particles optionally impregnated with a PGM. In one embodiment, the separate metal oxide component is selected from the group consisting of alumina, zirconia, and ceria, optionally impregnated with a Pt component, a Pd component, or a combination thereof. Exemplary mesoporous particles comprise silica nanoparticles, such as SBA-15 or MCM-41 particles, optionally impregnated with a PGM.

The automotive catalyst composite can be used as a single layer catalyst washcoat or as part of a multi-layer structure. For example, the automotive catalyst composite can be used in the form of a single layer gasoline or diesel oxidation catalyst wherein the nanoparticles of the one or more refractory metal oxides of the shell are impregnated with a PGM. In other embodiments, the automotive catalyst composite is in the form of a multi-layer gasoline Three Way Catalyst (TWC catalyst) comprising the core-shell support particles as a first layer and a second layer overlying the first layer comprising a refractory metal oxide and an oxygen storage component (e.g., ceria-zirconia) impregnated with a PGM (e.g., a Pd component, a Rh component, or a combination thereof). In yet another embodiment, the automotive catalyst composite is used in the form of a multi-layer gasoline Three Way Catalyst (TWC catalyst) comprising the core-shell support particles as a first layer, and second layer of refractory metal oxide impregnated with PGM (e.g., a Pt component, a Pd component, or a combination thereof), overlying the first layer, and a third layer overlying the second layer comprising a mixture of refractory oxide and an oxygen storage component impregnated with a PGM (e.g., a Pd component, a Rh component, or a combination thereof).

The placement of the automotive catalyst composite of the invention in an exhaust treatment system can vary, and can include placement of the catalytic material containing core-shell support particles in a close coupled or underfloor position of a gasoline exhaust system.

In one particular embodiment, the automotive catalyst composite of the invention is in a form effective as a catalyst to convert hydrocarbons (HC), carbon monoxide (CO), and NOx, and wherein the core comprises particles of one or more molecular sieves having a primary particle size distribution d₉₀ in the range of about 0.1 μm to about 5 μm and particles of one or more refractory metal oxides having a primary particle size distribution d₉₀ in the range of about 0.1 μm to about 5 μm; wherein the shell comprises nanoparticles of one or more refractory metal oxides having a primary particle size distribution d₉₀ in the range of about 5 nm to about 100 nm (0.1 μm); and further comprising one or more platinum group metals (PGMs) impregnated on the core-shell support; wherein the core-shell support particles have an average pore radius greater than about 30 Å as measured by N₂ porosimetry.

In another aspect, the invention provides an exhaust gas treatment system comprising the automotive catalyst composite of any of the embodiments set forth herein located downstream of an internal combustion engine, such as a gasoline or diesel engine.

In yet another aspect, the invention provides a method for treating an exhaust gas comprising hydrocarbons and carbon monoxide, the method comprising contacting the exhaust gas with the automotive catalyst composite of any of the embodiments set forth herein. In a still further aspect, the invention provides a method of making an automotive catalyst composite, the method comprising, for example, obtaining a plurality of particles in an aqueous suspension for a core structure, the particles having a primary particle size distribution d₉₀ of up to about 5 μm and comprising one or more molecular sieves; obtaining a solution of nanoparticles of one or more refractory metal oxides having a primary particle size distribution d₉₀ in the range of about 5 nm to about 1000 nm (1 μm); mixing the aqueous suspension for the core structure and the solution of nanoparticles to form a mixture; spray-drying the mixture for form a plurality of core-shell support particles; optionally impregnating the core-shell support particles with one or more platinum group metals (PGMs) to form a catalytic material; and depositing the catalytic material on a carrier. The aqueous suspension for the core structure may further include particles of one or more refractory metal oxides. The one or more PGMs impregnated on the core-shell support can be selected from the group consisting of platinum (Pt), rhodium (Rh), palladium (Pd), iridium (Ir), ruthenium (Ru), and combinations thereof.

The invention also provides a particulate material adapted for use as a coating on a catalyst article, comprising a plurality of core-shell support particles comprising a core and a shell surrounding the core, wherein the core comprises a plurality of particles having a primary particle size distribution d₉₀ of up to about 5 μm, wherein the core particles comprise particles of one or more molecular sieves and optionally particles of one or more refractory metal oxides; wherein the shell comprises nanoparticles of one or more refractory metal oxides, wherein the nanoparticles have a primary particle size distribution d₉₀ in the range of about 5 nm to about 1000 nm (1 μm); and optionally, one or more platinum group metals (PGMs) on the core-shell support, wherein the core-shell support particles are in dry form or in aqueous slurry form.

The invention includes, without limitation, the following embodiments.
Embodiment 1: An automotive catalyst composite comprising:
   a catalytic material on a carrier, the catalytic material comprising a plurality of core-shell support particles comprising a core and a shell surrounding the core,
   wherein the core comprises a plurality of particles having a primary particle size distribution d₉₀ of up to about 5 μm, wherein the core particles comprise particles of one or more molecular sieves and optionally particles of one or more refractory metal oxides; and
   wherein the shell comprises nanoparticles of one or more refractory metal oxides, wherein the nanoparticles have a primary particle size distribution d₉₀ in the range of about 5 nm to about 1000 nm (1 μm); and
   optionally, one or more platinum group metals (PGMs) on the core-shell support;
   wherein the catalytic material is effective to temporarily trap hydrocarbons in a vehicle exhaust stream and thereafter release the trapped hydrocarbons and convert the hydrocarbons to carbon oxides and water.
Embodiment 2: The automotive catalyst composite of any preceding or subsequent embodiment, wherein the shell has a thickness in the range of about 1 to about 10 μm.
Embodiment 3: The automotive catalyst composite of any preceding or subsequent embodiment, wherein the shell has a thickness in the range of about 2 to about 6 μm.
Embodiment 4: The automotive catalyst composite of any preceding or subsequent embodiment, wherein the shell has a thickness of about 10 to about 50% of an average particle diameter of the core-shell support.
Embodiment 5: The automotive catalyst composite of any preceding or subsequent embodiment, wherein the core has a diameter in the range of about 5 to about 20 μm.
Embodiment 6: The automotive catalyst composite of any preceding or subsequent embodiment, wherein the core-shell support comprises about 50 to about 95% by weight of the core and about 5 to about 50% by weight of the shell, based on the total weight of the core-shell support.
Embodiment 7: The automotive catalyst composite of any preceding or subsequent embodiment, wherein the core-shell support has an average particle diameter in the range of about 8 μm to about 30 μm.
Embodiment 8: The automotive catalyst composite of any preceding or subsequent embodiment, wherein the core comprises particles of the molecular sieve having a primary particle size distribution d₉₀ in the range of about 0.1 to about 5 μm.
Embodiment 9: The automotive catalyst composite of any preceding or subsequent embodiment, wherein the core comprises at least two molecular sieve types selected from the group consisting of small pore molecular sieve type, medium pore molecular sieve type, and large pore molecular sieve type.
Embodiment 10: The automotive catalyst composite of any preceding or subsequent embodiment, wherein the refractory metal oxide of the shell is selected from the group consisting of alumina, zirconia-alumina, ceria, ceria-zirconia, zirconia, titania, silica, silica-alumina, manganese oxide, and combinations thereof.
Embodiment 11: The automotive catalyst composite of any preceding or subsequent embodiment, wherein the shell further comprises a base metal oxide selected from the group consisting of lanthana, baria, strontium oxide, calcium oxide, magnesium oxide, and combinations thereof.
Embodiment 12: The automotive catalyst composite of any preceding or subsequent embodiment, wherein the base metal oxide is present in an amount of about 1 to about 20% by weight, based on the weight of the core-shell support.
Embodiment 13: The automotive catalyst composite of any preceding or subsequent embodiment, wherein the molecular sieve is selected from the group consisting of chabazite, ferrierite, clinoptilolite, silico-alumino-phosphate (SAPO), beta-zeolite, Y-zeolite, mordenite, ZSM-5, and combinations thereof.
Embodiment 14: The automotive catalyst composite of any preceding or subsequent embodiment, wherein the molecular sieve is ion-exchanged with a metal selected from the group consisting of La, Ba, Sr, Mg, Pt, Pd, Ag, Cu Ni, Co, Fe, Zn, and combinations thereof.
Embodiment 15: The automotive catalyst composite of any preceding or subsequent embodiment, wherein the core-shell support has an average pore radius greater than about 30 Å as measured by N₂ porosimetry.
Embodiment 16: The automotive catalyst composite of any preceding or subsequent embodiment, wherein one or more PGMs is impregnated on the shell, the PGMs being selected from the group consisting of a Pt component, a Pd component, or combinations thereof.
Embodiment 17: The automotive catalyst composite of any preceding or subsequent embodiment, wherein a weight ratio of Pt to Pd is in the range of about 5:1 to about 1:5.
Embodiment 18: The automotive catalyst composite of any preceding or subsequent embodiment, wherein the total amount of Pt and Pd is about 0.1 to about 5% by weight, based on the total weight of the core-shell support.
Embodiment 19: The automotive catalyst composite of any preceding or subsequent embodiment, wherein the carrier is a flow-through substrate or a wall-flow filter.
Embodiment 20: The automotive catalyst composite of any preceding or subsequent embodiment, wherein the loading of the core-shell support particles on the carrier is about 0.5 to about 2.5 g/in³.
Embodiment 21: The automotive catalyst composite of any preceding or subsequent embodiment, further comprising a refractory metal oxide binder.
Embodiment 22: The automotive catalyst composite of any preceding or subsequent embodiment, further comprising a separate metal oxide component mixed with the core-shell support particles, the separate metal oxide component optionally impregnated with a PGM.
Embodiment 23: The automotive catalyst composite of any preceding or subsequent embodiment, wherein the separate metal oxide component is selected from the group consisting of alumina, zirconia, and ceria, optionally impregnated with a Pt component, a Pd component, or a combination thereof.
Embodiment 24: The automotive catalyst composite of any preceding or subsequent embodiment, further comprising a separate component mixed with the core-shell support particles, the separate component comprising mesoporous particles optionally impregnated with a PGM.
Embodiment 25: The automotive catalyst composite of any preceding or subsequent embodiment, wherein the mesoporous particles comprise silica nanoparticles.
Embodiment 26: The automotive catalyst composite of any preceding or subsequent embodiment, in the form of a single layer gasoline or diesel oxidation catalyst wherein the nanoparticles of the one or more refractory metal oxides of the shell are impregnated with a PGM.
Embodiment 27: The automotive catalyst composite of any preceding or subsequent embodiment, in the form of a multi-layer gasoline Three Way Catalyst (TWC catalyst) comprising either (i) the core-shell support particles as a first layer and a second layer overlying the first layer comprising a refractory metal oxide and an oxygen storage component impregnated with a PGM; or (ii) the core-shell support particles as a first layer, a second layer of refractory metal oxide impregnated with PGM, overlying the first layer, and a third layer overlying the second layer comprising a mixture of refractory oxide and an oxygen storage component impregnated with a PGM.
Embodiment 28: The automotive catalyst composite of any preceding or subsequent embodiment, wherein the PGM of the second layer or the third layer is selected from the group consisting of a Pd component, a Rh component, and combinations thereof.
Embodiment 29: The automotive catalyst composite of any preceding or subsequent embodiment, wherein the catalytic material is zoned with a different catalytic material along a length of the carrier or wherein the catalytic material is layered with a different catalytic material on the carrier.
Embodiment 30: The automotive catalyst composite of any preceding or subsequent embodiment, in a form effective as a catalyst to convert hydrocarbons (HC), carbon monoxide (CO), and NOx,
   wherein the core comprises particles of one or more molecular sieves having a primary particle size distribution d₉₀ in the range of about 0.1 μm to about 5 μm and particles of one or more refractory metal oxides having a primary particle size distribution d₉₀ in the range of about 0.1 μm to about 5 μm;
   wherein the shell comprises nanoparticles of one or more refractory metal oxides having a primary particle size distribution d₉₀ in the range of about 5 nm to about 100 nm (0.1 μm); and
   further comprising one or more platinum group metals (PGMs) impregnated on the core-shell support;
   wherein the core-shell support particles have an average pore radius greater than about 30 Å as measured by N₂ porosimetry.
Embodiment 31: An exhaust gas treatment system comprising the automotive catalyst composite of any preceding or subsequent embodiment located downstream of an internal combustion engine.
Embodiment 32: A method for treating an exhaust gas comprising hydrocarbons and carbon monoxide, the method comprising contacting the exhaust gas with the automotive catalyst composite of any preceding or subsequent embodiment.
Embodiment 33: A method of making an automotive catalyst composite, the method comprising:
   obtaining a plurality of particles in an aqueous suspension for a core structure, the particles having a primary particle size distribution d₉₀ of up to about 5 μm and comprising one or more molecular sieves;
   obtaining a solution of nanoparticles of one or more refractory metal oxides having a primary particle size distribution d₉₀ in the range of about 5 nm to about 1000 nm (1 μm);
   mixing the aqueous suspension for the core structure and the solution of nanoparticles to form a mixture;
   spray-drying the mixture for form a plurality of core-shell support particles;
   optionally impregnating the core-shell support particles with one or more platinum group metals (PGMs) to form a catalytic material; and
   depositing the catalytic material on a carrier.
Embodiment 34: The method of any preceding or subsequent embodiment, wherein the aqueous suspension for the core structure further comprises particles of one or more refractory metal oxides.
Embodiment 35: The method of any preceding or subsequent embodiment, wherein one or more PGMs are impregnated on the core-shell support and are selected from the group consisting of platinum (Pt), rhodium (Rh), palladium (Pd), iridium (Ir), ruthenium (Ru), and combinations thereof.
Embodiment 36: A particulate material adapted for use as a coating on a catalyst article, comprising:
   a plurality of core-shell support particles comprising a core and a shell surrounding the core,
   wherein the core comprises a plurality of particles having a primary particle size distribution d₉₀ of up to about 5 μm, wherein the core particles comprise particles of one or more molecular sieves and optionally particles of one or more refractory metal oxides; and
   wherein the shell comprises nanoparticles of one or more refractory metal oxides, wherein the nanoparticles have a primary particle size distribution d₉₀ in the range of about 5 nm to about 1000 nm (1 μm); and
   optionally, one or more platinum group metals (PGMs) on the core-shell support, wherein the core-shell support particles are in dry form or in aqueous slurry form.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present invention will become apparent from the following.

### BRIEF DESCRIPTION OF THE DRAWINGS

The disclosure may be more completely understood in consideration of the following detailed description of various embodiments of the disclosure in connection with the accompanying drawings, in which:

FIG. 1 provides a graph of formation of CO₂ and conversion (%) of CO and HC versus temperature (° C.) of a comparative material after aging at 750° C. (12 hours/10% steamed air);

FIG. 2 provides a graph of formation of CO₂ and conversion (%) of CO and HC versus temperature (° C.) of a comparative material after aging at 750° C. (12 hours/10% steamed air);

FIG. 3 provides a graph of formation of CO₂ and conversion (%) of CO and HC versus time (seconds) of a comparative material after aging at 750° C. (12 hours/10% steamed air);

FIG. 4 provides a graph of formation (%) of CO₂ versus temperature (° C.) for an inventive material as compared to two comparative materials after aging at 750° C. (12 hours/10% steamed air);

FIG. 5 provides a graph formation (%) of CO₂ versus temperature (° C.) for an inventive material as compared to three comparative materials after aging at 850° C. (12 hours/10% steamed air);

FIGS. 6A-6C are scanning electron microscope (SEM) photographs at two different magnifications of a support of 15% alumina shell wrapping 85% beta-zeolite core, with FIG. 6B showing a relatively intact particle and FIG. 6C showing a broken particle with the core visible;

FIGS. 7A-7C are scanning electron microscope (SEM) photographs at three different magnifications of a support of 25% alumina shell wrapping 75% beta-zeolite core;

FIGS. 8A-8C are scanning electron microscope (SEM) photographs at three different magnifications of a support of 20% alumina shell wrapping a core of 45% beta-zeolite and 35% ZSM-5;

FIGS. 9A-9C are scanning electron microscope (SEM) photographs at two different magnifications of a support of 25% zirconia wrapping a core of beta-zeolite;

FIG. 10 is a dV/d log (r) graph of pore volume distribution versus pore radius (Å) for two inventive supports and a comparative support after aging at 850° C. (12 hours/10% steamed air);

FIGS. 11A-11E illustrate exemplary multi-layer catalyst structures including the automotive catalyst composite of the invention adapted for use in gasoline engine emission control systems;

FIGS. 12A-12F illustrate exemplary multi-layer catalyst structures including the automotive catalyst composite of the invention adapted for use in diesel engine emission control systems;

FIG. 13A is a perspective view of a honeycomb-type substrate which may comprise an automotive catalyst composite of the invention;

FIG. 13B is a partial cross-sectional view enlarged relative to FIG. 13A and taken along a plane parallel to the end faces of the carrier of FIG. 13A, which shows an enlarged view of a plurality of the gas flow passages shown in FIG. 13A; and

FIG. 14 shows a schematic depiction of an embodiment of an emission treatment system in which an automotive catalyst composite of the invention is utilized.

### DETAILED DESCRIPTION

The invention relates to hydrocarbon oxidation catalyst composites that include core-shell support particles that provide hydrocarbon trapping functionality. Platinum group metals (PGMs) may be supported on the core-shell support to form an integrated catalytic material. The catalyst composites include a core of a plurality of molecular sieve particles and a protective porous shell of nanoparticles of a refractory metal oxide. The catalyst composites of the invention provide a number of benefits in certain embodiments, such as stabilization of the core and enhanced protection of PGM components from poisoning associated with Si—O vapor migration. The core-shell support is considered porous, with exemplary embodiments having an average pore radius of greater than 30 Å as measured by N₂ porosimetry.

Although certain prior art references suggest a surface layer of alumina or zirconia around a zeolite material, such a layer cannot completely act as protective layer. The present invention provides a more effective method wherein a plurality of zeolite particles are enwrapped with a relatively thick protective layer, but the resulting particles maintain an effective particle size distribution to allow for a coating on a monolithic substrate without destroying the external shell. To accomplish this, zeolite particles used in the core have a primary particle size distribution d₉₀ of up to about 5 μm (such as up to about 3 μm), which can be accomplished by milling commercially available zeolite particles, which are often as large as 60-80 μm, to the desired size range (e.g., using dry or slurry milling) In addition, the shell of the core-shell particles is made using, for example, colloidal nanoparticles in a range of up to 1 μm. This range will allow for developing a shell with a desired thickness and porosity.

The invention provides core-shell support particles with a size suitable for monolith substrate coating (e.g., 5-30 μm). Importantly, the core-shell support particles are provided in the coatable size range without the requirement of milling the core-shell particles, which would damage the shell and expose the molecular sieve particles of the core. Milling the particles as suggested in certain patents to achieve coatable size particles will defeat the purpose of creating a core-shell particle by exposing the zeolite particles.

The following definitions are used herein.

As used herein, “platinum group metal (PGM) component,” “platinum (Pt) component,” “rhodium (Rh) component,” “palladium (Pd) component,” “iridium (Ir) component,” “ruthenium (Ru) component” and the like refers to the respective platinum group metal in a base metal or compound (e.g., oxide) form.

“BET surface area” has its usual meaning of referring to the Brunauer-Emmett-Teller method for determining surface area by N₂-adsorption measurements. Unless otherwise stated, “surface area” refers to BET surface area.

“Primary particles” refers to individual particles of material.

“Agglomerate” refers to an assembly of primary particles in that primary particles are clustered or adhered together.

“Primary particle size distribution d₉₀” refers to a characteristic of particles that indicates that 90% of the particles have a Feret diameter of a specified range as measured by Scanning Electron Microscopy (SEM) or Transmission Electron Microscopy (TEM).

“Washcoat” is a thin, adherent coating of a catalytic or other material applied to a substrate, such as a honeycomb flow-through monolith substrate or a filter substrate, which is sufficiently porous to permit the passage there through of the gas stream being treated.

### Core-Shell Support Particles

The automotive catalyst composite includes a plurality of core-shell support particles comprising a core and a shell surrounding the core. The core typically comprises a plurality of particles having a primary particle size distribution d₉₀ of up to about 5 μm, wherein the core particles comprise particles of one or more molecular sieves and optionally particles of one or more refractory metal oxides. As noted above, the core structure comprises molecular sieve particles, and optionally refractory metal oxides or other metal oxide particles, of a desired size: a primary particle size distribution d₉₀ in the range of about 0.1 μm to about 5 μm (preferably a d₉₀ in the range of about 0.25 to about 3 μm). The particles of the core may be milled from larger particles (e.g., agglomerated particles) to achieve the desired size range of primary particles. The milling of the molecular sieve particles, typically in slurry form, may be accomplished in a ball mill or other similar equipment, and the solids content of the slurry during milling may be, e.g., about 10-50 wt. %, more particularly about 10-40 wt. %.

As used herein, the term “molecular sieves” refers to zeolites and other zeolitic framework materials (e.g. isomorphously substituted materials), which may, in particulate form, support catalytic metals. Molecular sieves are materials based on an extensive three-dimensional network of oxygen ions containing generally tetrahedral type sites and having a substantially uniform pore distribution, with the average pore size being no larger than 20 Å. The pore sizes are defined by the ring size. As used herein, the term “zeolite” refers to a specific example of a molecular sieve, further including silicon and aluminum atoms. According to one or more embodiments, it will be appreciated that by defining the molecular sieves by their structure type, it is intended to include the structure type and any and all isotypic framework materials such as silico-alumino-phosphate (SAPO), alumino-phosphate (ALPO) and metal-alumino-phosphate (MeAPO) materials having the same structure type, as well as borosilicates, gallosilicates, mesoporous silica materials such as SBA-15 or MCM-41, and the like.

In certain embodiments, the molecular sieve may comprise a zeolite or zeotype selected from the group consisting of a chabazite, ferrierite, clinoptilolite, silico-alumino-phosphate (SAPO), beta-zeolite, Y-zeolite, mordenite, ZSM-5, mesoporous materials, and combinations thereof. The zeolite may be ion-exchanged with a metal, such as a metal selected from the group consisting of La, Ba, Sr, Mg, Pt, Pd, Ag, Cu Ni, Co, Fe, Zn, and combinations thereof.

The core may comprise one or more molecular sieve types selected from the group consisting of: small pore molecular sieve type, medium pore molecular sieve type, and large pore molecular sieve type. The small pore molecular sieve type may comprise an 8-member ring zeolite. The medium pore molecular sieve type may comprise a 10-member ring zeolite. The large pore molecular sieve type may comprise a 12-member ring zeolite. The 8-member ring zeolite may be ion-exchanged with one or more of copper and iron, having a CHA, SAPO, or AEI structure. The 10- or 12-member ring zeolite may comprise the metal promoter and a structure type of ZSM-5, Beta, or MFI in a H⁺, NH⁴⁺, Cu-exchanged, or Fe-exchanged form.

The core of the particles has an exemplary diameter in the range of about 5 to about 20 μm, such as about 5 to about 15 μm, which can be measuring using Scanning Electron Microscopy (SEM).

Preparation of the metal ion-exchanged molecular sieve typically comprises an ion-exchange process of the molecular sieve in particulate form with a metal precursor solution. For example, metal ion-exchanged molecular sieves have previously been prepared using ion-exchange techniques described in U.S. Pat. No. 9,138,732 to Bull et al. and U.S. Pat. No. 8,715,618 to Trukhan et al., which are incorporated by reference therein in their entireties.

In addition to molecular sieves, other Si—O trapping agents can be added to the core particles. For example, refractory metal oxide particles, including any of the refractory metal oxides noted in the discussion of the shell material (e.g., alumina, lanthana-zirconia, zirconia, baria-alumina, titania, and the like) may be milled to same level as the molecular sieve (i.e., a primary particle size distribution d₉₀ in the range of about 0.1 μm to about 5 μm) and spray dried together with the molecular sieve to create intimate molecular sieve and Si—O trap particles. Using colloidal compositions composed of base metal oxides, such as baria, lanthana, and alumina, can improve significantly the trapping efficiency of the migrating SiO to form the corresponding silicate salt (e.g., Ba silicate) and prevent its migration to the PGM component of a catalyst material.

The shell structure around the core structure comprises nanoparticles of one or more refractory metal oxides. Upon formation of the core-shell support by spray drying, the particles of the shell are agglomerated, which means the primary particles are clustered together to form a highly porous shell structure to allow for gas diffusion into and out of the core. The use of nanoscale size particles creates an advantageous shell coating, unlike approaches that rely on solution impregnation of a soluble aluminum or zirconium salt to form a surface coating. Accordingly, the shell structure is formed from highly dispersed nanoparticles, such as particles from a colloidal solution, having a desired size. In preferred embodiments, the primary particle size distribution d₉₀ of the colloidal solution used to form the shell is in the range of about 5 nm to about 1000 nm (1 μm), more preferably a d₉₀ in the range 20 nm to about 500 nm. It is noted that, following spray drying and calcination, the nanoparticles in the shell may agglomerate or fuse together to form larger particles with a porous structure to allow for gas diffusion into and out of the zeolite core. Accordingly, the particle size range noted above for the shell materials refers to the particle size prior to spray drying and calcination, although some discernable nanoparticles can be viewed in the final spray-dried/calcined product in many embodiments. In other embodiments, the shell will be formed of agglomerates of such nanoparticles.

“Refractory metal oxides” refers to porous metal-containing oxide materials exhibiting chemical and physical stability at high temperatures, such as the temperatures associated with gasoline or diesel engine exhaust. Exemplary refractory oxides include alumina, silica, zirconia, titania, ceria, praseodymia, tin oxide, and the like, as well as physical mixtures or chemical combinations thereof, including atomically-doped combinations and including high surface area or activated compounds such as activated alumina. Exemplary combinations of metal oxides include silica-alumina, ceria-zirconia, praseodymia-ceria, alumina-zirconia, alumina-ceria-zirconia, lanthana-alumina, lanthana-zirconia-alumina, baria-alumina, baria-lanthana-alumina, baria-lanthana-neodymia alumina, and alumina-ceria. Exemplary aluminas include large pore boehmite, gamma-alumina, and delta/theta alumina. Useful commercial aluminas used as starting materials in exemplary processes include activated aluminas, such as high bulk density gamma-alumina, low or medium bulk density large pore gamma-alumina, and low bulk density large pore boehmite and gamma-alumina, available from BASF Catalysts LLC (Port Allen, La., U.S.A).

High surface area refractory oxide supports, such as alumina support materials, also referred to as “gamma alumina” or “activated alumina,” typically exhibit a BET surface area in excess of 60 m²/g, often up to about 200 m²/g or higher. Such activated alumina is usually a mixture of the gamma and delta phases of alumina, but may also contain substantial amounts of eta, kappa and theta alumina phases. “BET surface area” has its usual meaning of referring to the Brunauer, Emmett, Teller method for determining surface area by N₂ adsorption. Desirably, the active alumina has a specific surface area of 60 to 350 m²/g, and typically 90 to 250 m²/g.

In certain embodiments, refractory oxide supports useful in the catalyst compositions disclosed herein are doped alumina materials, such as Si-doped alumina materials (including, but not limited to, 1-10% SiO₂—Al₂O₃), doped titania materials, such as Si-doped titania materials (including, but not limited to, 1-10% SiO₂—TiO₂), or doped zirconia materials, such as Si-doped ZrO₂ (including, but not limited to, 5-30% SiO₂—ZrO₂).

Although alumina and zirconia may have some protective effect as the primary refractory metal oxide of the shell, such materials would not be highly effective at high aging conditions as observed in certain gasoline or diesel engines (e.g., at temperatures equal or greater than 850° C.). In such cases, it can be advantageous to use a refractory metal oxide with one or more additional metal oxide dopants, such as lanthana, baria, strontium oxide, calcium oxide, magnesium oxide, and combinations thereof. The metal oxide dopant is typically present in an amount of about 1 to about 20% by weight, based on the weight of the core-shell support.

The dopant metal oxides can be introduced using an incipient wetness impregnation technique or through usage of colloidal mixed oxide particles. Particularly preferred doped metal oxides include colloidal baria-alumina, baria-zirconia, baria-titania, zirconia-alumina, baria-zirconia-alumina, and the like. The doping with the base metal oxides is significant to stabilize the shell particles and to maintain good PGM dispersion after severe aging conditions.

In certain embodiments, the shell has a thickness in the range of about 1 to about 10 μm, and preferably about 2 to about 6 μm. In one embodiment, the shell has a thickness of about 10 to about 50% of an average particle diameter of the core-shell support (e.g., about 20 to about 30%). Typically, the core-shell support comprises about 50 to about 95% by weight of the core (e.g., about 60 to about 90%), and about 5 to about 50% by weight of the shell (e.g., about 10 to about 30%), based on the total weight of the core-shell support. The shell thickness can be selected based, in part, on the severity of the application. For example, higher aging temperatures would require a thicker shell, such as in the range of about 5 to about 10 μm. Thickness of the core and shell can be observed and measured using Scanning Electron Microscopy (SEM) or Transmission Electron Microscopy (TEM).

For the overall core-shell support, the average particle diameter is typically in the range of about 8 μm to about 30 μm. Average particle diameter is measured by measured by light scattering techniques (dynamic light scattering or static light scattering) or by measuring particle diameters visible in Scanning Electron Microscopy (SEM).

Optionally, one or more platinum group metals (PGMs) are impregnated on the shell of the core-shell support particles. Creating a continuous shell of the desired thickness noted herein allows the deposition of PGM on the external shell and minimizes the deposition of PGM on the zeolite particles. PGM on zeolite particles is ineffective for hydrocarbon oxidation reactions.

As used herein, “platinum group metal” or “PGM” refers to platinum group metals or oxides thereof, including platinum (Pt), palladium (Pd), ruthenium (Ru), rhodium (Rh), osmium (Os), iridium (Ir), and mixtures thereof. In other embodiments, the platinum group metal comprises platinum, palladium or a combination thereof, such as in a weight ratio of about 1:5 to about 5:1. In certain embodiments, the PGM component is platinum only or palladium only. In other embodiments, the PGM component is a combination of rhodium and platinum or rhodium and palladium or platinum, palladium, and rhodium. The concentrations of PGM component (e.g., Pt, Pd, or a combination thereof) can vary, but will typically be from about 0.1 wt.% to about 5 wt.% , based on the total weight of the core-shell support.

Water-soluble compounds (e.g., precursor salts) or water-dispersible compounds (colloidal particles) or complexes of the PGM component are typically used for impregnation. Generally, both from the point of view of economics and environmental aspects, aqueous solutions of soluble compounds or complexes of the PGM component are utilized. During the calcination step, or at least during the initial phase of use of the composite, such compounds are converted into a catalytically active form of the metal or a compound thereof. Exemplary water soluble salts of PGM components include amine salts, nitrate salts, and acetate salts.

The core-shell support may be formed by spray-drying an aqueous slurry made from the core and shell structure particles. The conditions for spray-drying can include, for example, a temperature of about 150-350° C. and atmospheric pressure. The spray-dried support may then be impregnated with a PGM to form an integrated catalytic material. The core-shell support and/or the integrated catalytic material may then be slurried and coated without any further milling onto a carrier, for example, a flow-through honeycomb substrate or a wall-flow substrate.

Upon formation of the core-shell support by spray-drying a molecular sieve in the presence of binding particles made of colloidal shell materials (e.g., alumina, zirconia, titania, ceria, and the like), the particles of the core may be adhered together by the colloidal particles.

### Substrate

According to one or more embodiments, the substrate for the catalyst composition may be constructed of any material typically used for preparing automotive catalysts and will typically comprise a metal or ceramic honeycomb structure. The substrate typically provides a plurality of wall surfaces upon which a catalyst washcoat composition is applied and adhered, thereby acting as a carrier for the catalyst composition.

Exemplary metallic substrates include heat resistant metals and metal alloys, such as titanium and stainless steel as well as other alloys in which iron is a substantial or major component. Such alloys may contain one or more of nickel, chromium, and/or aluminum, and the total amount of these metals may advantageously comprise at least 15 wt. % of the alloy, e.g., 10-25 wt. % of chromium, 3-8 wt. % of aluminum, and up to 20 wt. % of nickel. The alloys may also contain small or trace amounts of one or more other metals, such as manganese, copper, vanadium, titanium and the like. The surface or the metal carriers may be oxidized at high temperatures, e.g., 1000° C. and higher, to form an oxide layer on the surface of the substrate, improving the corrosion resistance of the alloy and facilitating adhesion of the washcoat layer to the metal surface.

Ceramic materials used to construct the substrate may include any suitable refractory material, e.g., cordierite, mullite, cordierite-α alumina, silicon nitride, zircon mullite, spodumene, alumina-silica magnesia, zircon silicate, sillimanite, magnesium silicates, zircon, petalite, α alumina, aluminosilicates and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which can be of any suitable cross-sectional shape, such as trapezoidal, rectangular, square, sinusoidal, hexagonal, oval, circular, and the like. Such structures may contain from about 60 to about 1200 or more gas inlet openings (i.e., “cells”) per square inch of cross section (cpsi), more usually from about 300 to 600 cpsi. The wall thickness of flow-through substrates can vary, with a typical range being between 0.002 and 0.1 inches. A representative commercially-available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry.

In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used a wall-flow filter substrates. However, it will be understood that the invention is not limited to a particular substrate type, material, or geometry. Note that where the substrate is a wall-flow substrate, the catalyst composition associated therewith (e.g., a CSF composition) can permeate into the pore structure of the porous walls (i.e., partially or fully occluding the pore openings) in addition to being disposed on the surface of the walls.

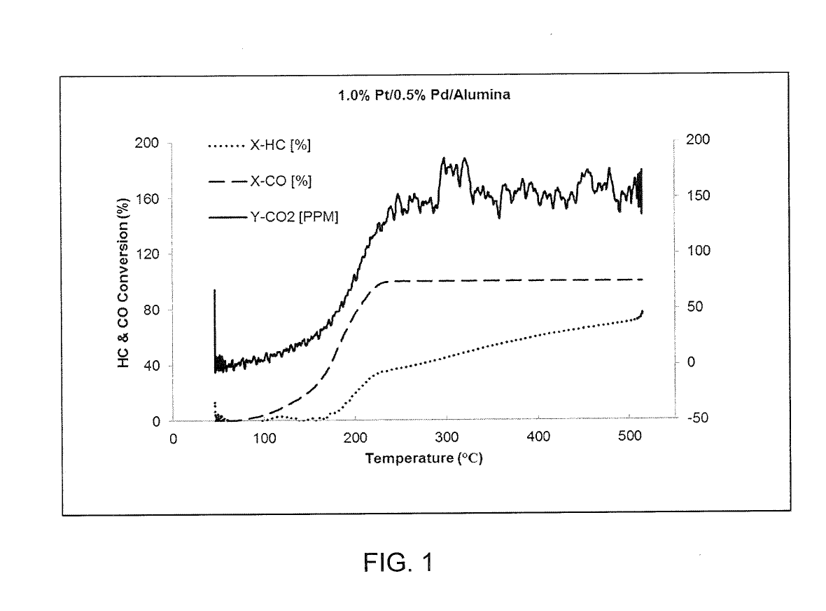

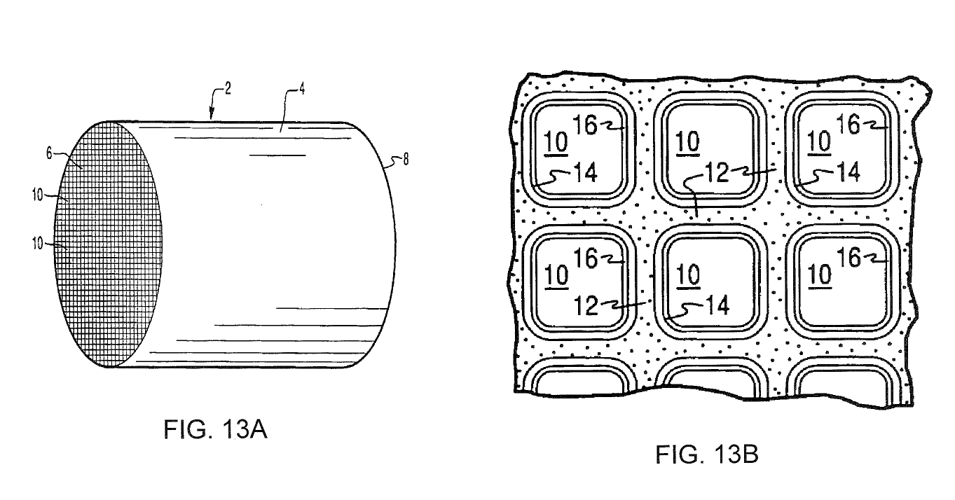

FIGS. 13A and 13B illustrate an exemplary substrate 2 in the form of a flow-through substrate coated with a washcoat composition as described herein. Referring to FIG. 13A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 1B, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 13B, walls 12 are so dimensioned and configured that gas flow passages 10 have a substantially regular polygonal shape. As shown, the washcoat composition can be applied in multiple, distinct layers if desired. In the illustrated embodiment, the washcoat consists of both a discrete bottom washcoat layer 14 adhered to the walls 12 of the carrier member and a second discrete top washcoat layer 16 coated over the bottom washcoat layer 14. The present invention can be practiced with one or more (e.g., 2, 3, or 4) washcoat layers and is not limited to the two-layer embodiment illustrated in FIG. 13B.

In describing the quantity of washcoat or catalytic metal components or other components of the composition, it is convenient to use units of weight of component per unit volume of catalyst substrate. Therefore, the units, grams per cubic inch (“g/in³”) and grams per cubic foot (“g/ft³”), are used herein to mean the weight of a component per volume of the substrate, including the volume of void spaces of the substrate. Other units of weight per volume such as g/L are also sometimes used. The total loading of the catalyst composition on the catalyst substrate, such as a monolithic flow-through substrate, is typically from about 0.5 to about 6 g/in³, and more typically from about 1 to about 5 g/in³. Total loading of the core-shell support particles is typically about 0.5 to about 2.5 g/in³. It is noted that these weights per unit volume are typically calculated by weighing the catalyst substrate before and after treatment with the catalyst washcoat composition, and since the treatment process involves drying and calcining the catalyst substrate at high temperature, these weights represent an essentially solvent-free catalyst coating as essentially all of the water of the washcoat slurry has been removed.

A dispersion of any of the catalytic materials described herein may be used to form a slurry for a washcoat. In addition to the catalyst particles, the slurry may optionally contain alumina or other refractory metal oxides as a binder, associative thickeners, and/or surfactants (including anionic, cationic, non-ionic or amphoteric surfactants). In one embodiment, the slurry is acidic, having a pH of about 2 to less than about 7. The pH of the slurry may be lowered by the addition of an adequate amount of an inorganic or an organic acid to the slurry. Thereafter, if desired, water-soluble or water-dispersible compounds stabilizers, e.g., barium acetate, and promoters, e.g., lanthanum nitrate, may be added to the slurry. In accordance with embodiments disclosed herein, preferably the slurry requires only minimal to no subsequent milling The carrier may then be dipped one or more times in such slurry or the slurry may be coated on the carrier such that there will be deposited on the carrier the desired loading of the washcoat. Thereafter the coated carrier is calcined by heating, e.g., at 500-600° C. for about 1 to about 3 hours. Additional layers may be prepared and deposited upon previous layers in the same manner as described above.

The automotive catalyst composite can include further components mixed with the core-shell support particles, such as a separate metal oxide component mixed with the core-shell support particles and optionally impregnated with a PGM, or separate mesoporous particles mixed with the core-shell support particles and optionally impregnated with a PGM. In one embodiment, the separate metal oxide component is selected from the group consisting of alumina, zirconia, and ceria, optionally impregnated with a Pt component, a Pd component, or a combination thereof. Exemplary mesoporous particles comprise silica nanoparticles, such as SBA-15 or MCM-41 particles, optionally impregnated with a PGM.

The automotive catalyst composite can be used as a single layer catalyst washcoat or as part of a multi-layer structure. For example, the automotive catalyst composite can be used in the form of a single layer gasoline or diesel oxidation catalyst wherein the nanoparticles of the one or more refractory metal oxides of the shell are impregnated with a PGM. In other embodiments, the automotive catalyst composite is in the form of a multi-layer gasoline Three Way Catalyst (TWC catalyst) comprising the core-shell support particles as a first layer and a second layer overlying the first layer comprising a refractory metal oxide, including any of the refractory metal oxides noted herein, and an oxygen storage component (e.g., ceria-zirconia) impregnated with a PGM (e.g., a Pd component, a Rh component, or a combination thereof). In yet another embodiment, the automotive catalyst composite is used in the form of a multi-layer gasoline Three Way Catalyst (TWC catalyst) comprising the core-shell support particles as a first layer, and second layer of refractory metal oxide impregnated with PGM (e.g., a Pt component, a Pd component, or a combination thereof), overlying the first layer, and a third layer overlying the second layer comprising a mixture of refractory oxide and an oxygen storage component impregnated with a PGM (e.g., a Pd component, a Rh component, or a combination thereof).

An oxygen storage component (OSC) is an entity that has multi-valent oxidation states and can actively react with oxidants such as oxygen (O₂) or nitric oxides (NO₂) under oxidative conditions, or reacts with reductants such as carbon monoxide (CO), hydrocarbons (HC), or hydrogen (H₂) under reduction conditions. Examples of suitable oxygen storage components include ceria and praseodymia. Delivery of an OSC to the washcoat layer can be achieved by the use of, for example, mixed oxides. For example, ceria can be delivered as a mixed oxide of cerium and zirconium, and/or a mixed oxide of cerium, zirconium, and neodymium. For example, praseodymia can be delivered as a mixed oxide of praseodymium and zirconium, and/or a mixed oxide of praseodymium, cerium, lanthanum, yttrium, zirconium, and neodymium.

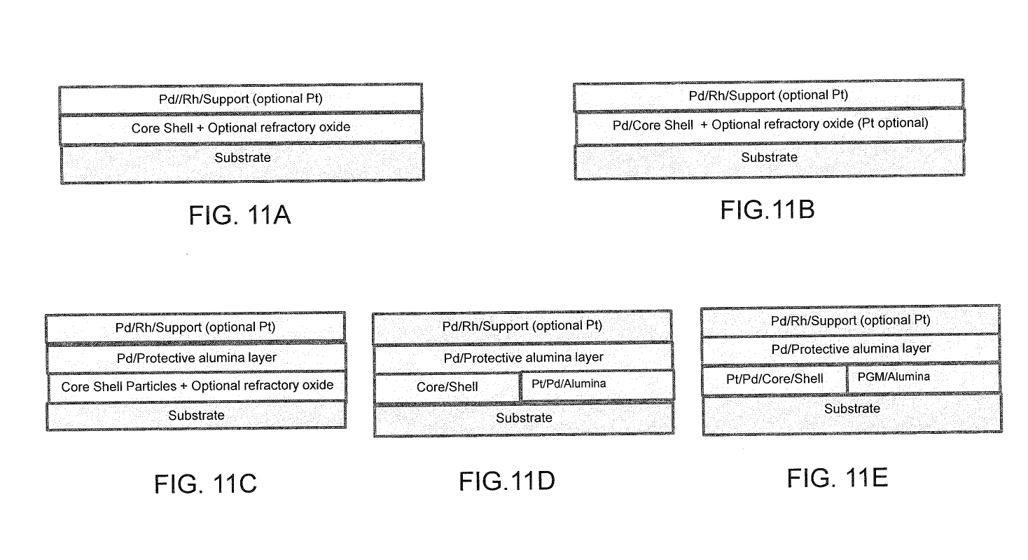

As noted above, the automotive catalyst composite can be zoned with a different catalytic material along a length of the carrier or layered with a different catalytic material on the carrier. For example, various exemplary layered and/or zoned configurations for gasoline engines are set forth in FIGS. 11A-11E. In FIG. 11A, the core-shell support particles with optional additional refractory oxide particles are coated in a first layer on the substrate and a second overlying layer comprises a support material (such as in refractory metal oxide noted herein) impregnated with palladium and rhodium and optionally platinum. Note that the support material for each PGM component can be the same or different, with exemplary different support materials including alumina, ceria-zirconia, lanthana-zirconia, and the like. FIG. 11B is similar to FIG. 11A, except it is noted that the core-shell support particles can include palladium (and optionally platinum) impregnated in the shell. FIG. 11C is similar to FIG. 11A except a middle protective alumina layer comprising palladium is placed between the outer PGM-containing layer and the inner core-shell support particle layer. FIGS. 11D and 11E are similar to FIG. 11C, except the core-shell support particles and a PGM-impregnated alumina are zone-coated as the first layer. In FIG. 11E, the zone-coated core-shell support particles further comprise PGM components impregnated into the shell.

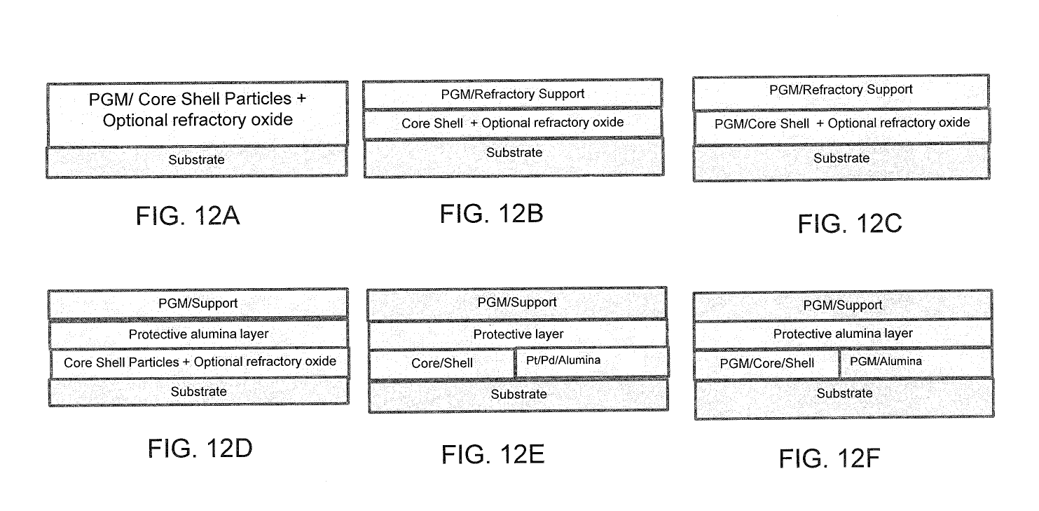

Various exemplary layered and/or zoned configurations for diesel engines are set forth in FIGS. 12A-12F. In FIG. 12A, core-shell support particles comprising at least one PGM component impregnated into the shell is provided as a single layer oxidation catalyst (optionally further including a refractory metal oxide). In FIG. 12B, the core-shell support particles in the bottom layer are combined with a PGM-containing refractory metal oxide top layer. FIG. 12C is similar to FIG. 12B, except the core-shell support particles of the bottom layer include a PGM component in the shell. FIG. 12D is similar to FIG. 12B, except an intervening protective alumina layer is placed between the top layer and the bottom layer. FIGS. 12E and 12F are similar to FIG. 12D, except the bottom layer is zone coated in a manner similar to FIGS. 11D and 11E.

In addition to alumina as the protective layer noted in certain embodiments of FIG. 11 and FIG. 12, other refractory metal oxides could be used such as the various metal oxides noted herein, with specific examples including baria-alumina and lanthana-zirconia, as well as various refractory metal oxides (e.g., alumina) doped with other metal oxides such as lanthana, baria, strontium oxide, calcium oxide, magnesium oxide, and combinations thereof.

### Emission Treatment System

The present invention also provides an emission treatment system that incorporates the catalyst compositions described herein. A catalyst article comprising the catalyst composition of the present invention is typically used in an integrated emissions treatment system comprising one or more additional components for the treatment of exhaust gas emissions. The relative placement of the various components of the emission treatment system can be varied. For example, the emission treatment system may further comprise a selective catalytic reduction (SCR) catalytic article. The treatment system can include further components, such as ammonia oxidation (AMOx) materials, ammonia-generating catalysts, and NOx storage and/or trapping components (LNTs). The preceding list of components is merely illustrative and should not be taken as limiting the scope of the invention.

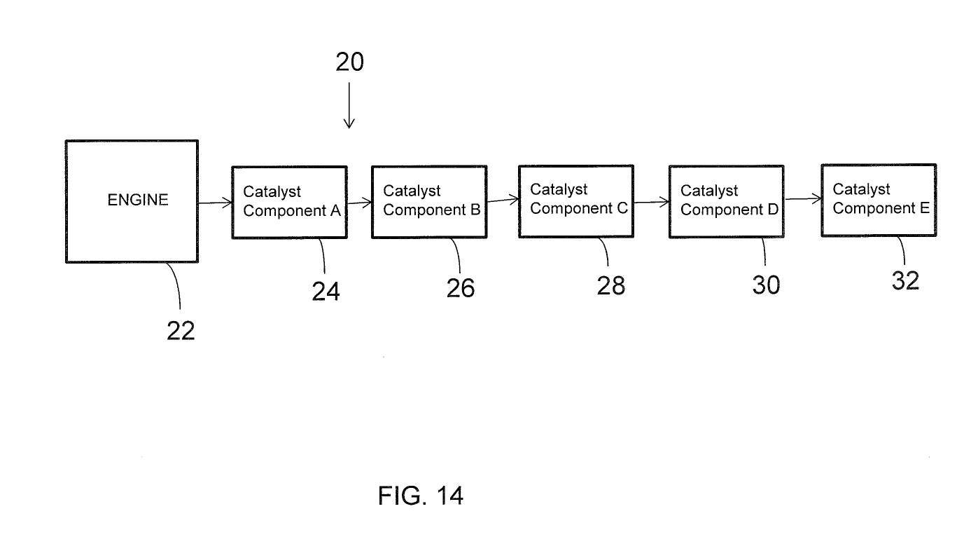

One exemplary emission treatment system is illustrated in FIG. 14, which depicts a schematic representation of an emission treatment system 20. As shown, the emission treatment system can include a plurality of catalyst components in series downstream of an engine 22 (e.g., a gasoline, diesel, or lean burn gasoline engine). At least one of the catalyst components will be the oxidation catalyst of the invention as set forth herein. The catalyst composition of the invention could be combined with numerous additional catalyst materials and could be placed at various positions in comparison to the additional catalyst materials. FIG. 14 illustrates five catalyst components, 24, 26, 28, 30, 32 in series; however, the total number of catalyst components can vary and five components is merely one example. The catalyst composition of the invention could be placed in a close coupled or underfloor position of an exhaust treatment system.

Before describing several exemplary embodiments of the invention, it is to be understood that the invention is not limited to the details of construction or process steps set forth in the following description. The invention is capable of other embodiments and of being practiced in various ways. In the following, preferred designs are provided, including such combinations as recited used alone or in unlimited combinations, the uses for which include catalysts, systems, and methods of other aspects of the present invention.

### EXAMPLES

The following non-limiting examples shall serve to illustrate the various embodiments of the present invention.

A series of catalytic materials was prepared. Inventive catalytic materials used a spray-dried (SD) core-shell support. Comparative catalytic materials used supports of alumina or zeolite. For these examples, platinum (Pt) and palladium (Pd) were used in combination.
Preparation procedure of Pt/Pd catalyst (also referred to as catalytic material): Pt & Pd nitrate solutions were mixed to a predetermined amount to supply about 1% Pt and 0.5% Pd on the support after powder impregnation and calcination. The Pt & Pd nitrate solution was diluted in water prior to impregnation for 100% incipient wetness. After impregnation, the Pt/Pd on support was dried at 110° C. for 2-3 hours and calcined in air at 550° C. for 2 hours.
Processing and testing. The catalytic materials were processed to allow for testing in a powder lab reactor. The materials were mixed in water and alumina sol solution (5% alumina binder) to form a slurry, which is then dried, followed by calcination at 550° C. for 1 hour. The materials then were sieved to an agglomerated particle size distribution (PSD) between 100 to 200 μm. After sieving, the catalytic materials were then aged in 10% steamed air under two separate conditions: 750° C. for 12 hours and/or 850° C. for 12 hours prior to evaluation for Hydrocarbon (HC) Trapping Efficiency. After aging, 3 grams of the processed catalytic materials were loaded into a plug flow reactor. The catalysts were evaluated in a gas flow with composition containing decane+Toluene (350 ppm Cl at a ratio of 2:1, CO=700 ppm, 10% O₂, 100 ppm NO, 5% steam, and balance is N₂) at a space velocity of 30,000/h. After exposing the catalyst at 50° C. to the reaction mixture for a soaking period: 3 minutes (for 850° C. aged samples) or 15 minutes (for 750° C. aged samples), the temperature of the reactor was ramped up linearly to 500° C. at a rate of 20 K/min. The products were analyzed using gas chromatography/mass spectrometry (GC/MS). The testing results were plotted as % Conversion vs. Time or % Conversion vs. Temperature.
Interpretation of the Evaluation Results: HC trapping is recognized during the soaking period (of 3 or 15 minutes) for all samples containing Beta or ZSM-5 or their combination. HC trapping appears as almost 50% conversion during the soaking period. After soaking, the temperature is ramped up in full feed at 20 K/min up to 500° C. During that period, some of the trapped HC is released as the temperature increases the CO is converted to CO₂ and the HC is converted to CO₂. The light-off temperature for CO is measured at 50% CO conversion. The amount of CO₂ produced is a good indication of trapping efficiency as well as conversion of trapped material to CO₂ (from CO & HC oxidation). The amount of CO₂ due to combustion of CO (700 ppm) and HC to CO₂ (350 ppm C1) should be about 1050 ppm (given in the results as 150% conversion). Any increase over 150% conversion or over 1050 ppm is an indication of HC trap and conversion efficiency. However some of the HC is converted to CO and this is indicated by the negative peak for CO formation.

### Comparative Example 1

1% Pt/0.5% Pd on alumina: 1% Pt & 0.5% Pd was impregnated on gamma alumina powder with surface area of about 150 m²/g, dried, and calcined according to the preparation procedure discussed above to form the catalyst. The catalyst was then processed and tested as discussed above. The catalyst did not contain HC trapping material. The amount of CO₂ produced was a combination of CO & HC oxidation (CO₂ from CO=700 ppm) and CO₂ from HC=350 ppm. The measured CO₂ formation, therefore, was 1050 ppm. The % CO₂ formation was amount of CO₂ formed divided by 700×100%. This corresponded to 150% conversion. FIG. 1 shows testing results after of the Pt-Pd-alumina catalyst after 750° C. aging (12 hours/10% steamed air). Amount of HC released was zero (no trapping or release).

### Comparative Example 2

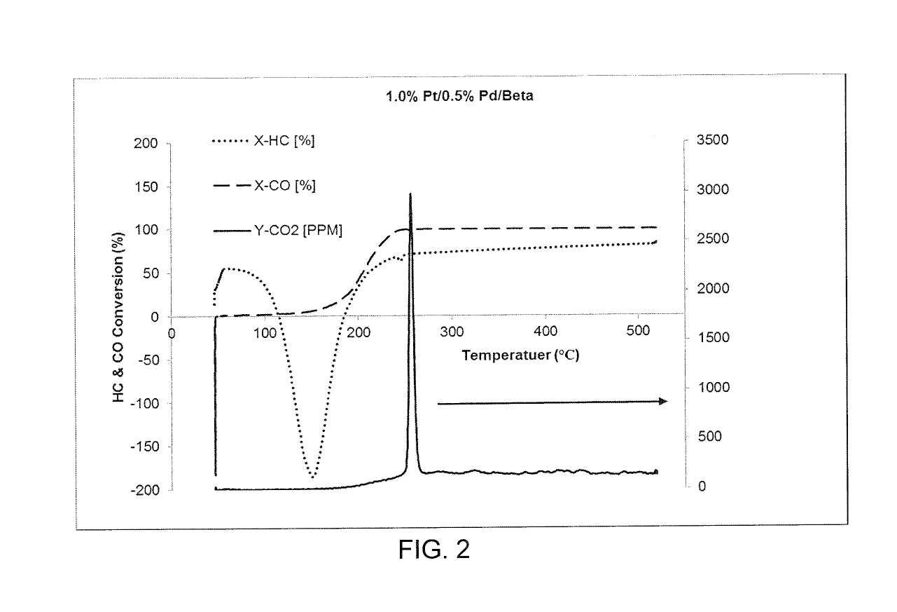

1% Pt/0.5% Pd on Beta Zeolite: 1% Pt & 0.5% Pd was impregnated on spray-dried Beta-zeolite powder with SiO₂/Al₂O₃ ratio of 30 calcined according to the preparation procedure discussed above. The catalyst was shaped and tested as discussed above. The catalyst showed strong trapping properties at 50° C. When the catalyst temperature was ramped up to 500° C. at 20 K/min, some of the HC was released and measured as negative conversion. The amount of CO₂ produced was a combination of CO & HC oxidation (CO₂ from CO=700 ppm) and CO₂ from the combusted HC. FIG. 2 shows results from the HC trap and release from the 1% Pt/0.5% Pd on beta-zeolite (spray-dried) catalyst after 750° C. aging (12 hours/10% steamed air). Amount of HC released was about −200%.

### Comparative Example 3

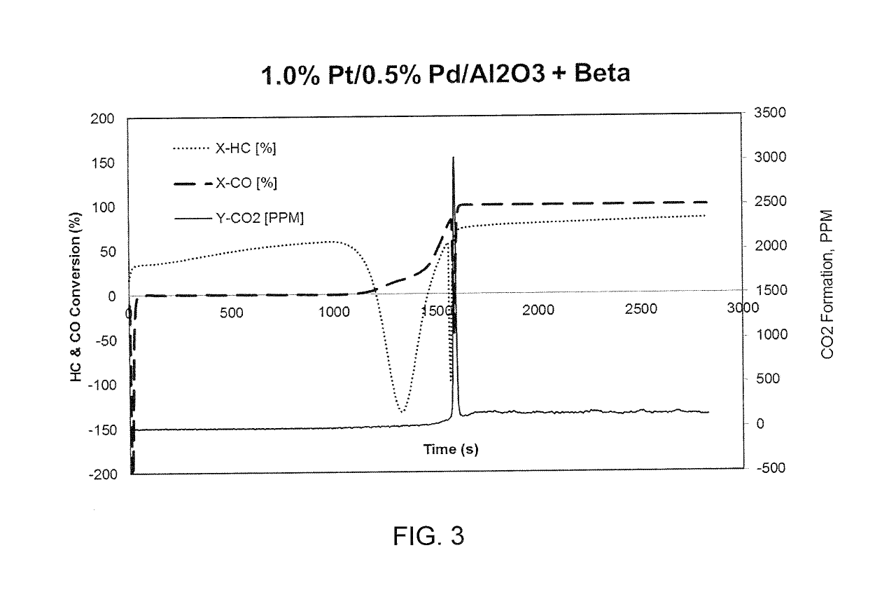

1% Pt/0.5% Pd on Alumina (25%)+mechanical mixture of Beta Zeolite (75%): 1% Pt & 0.5% Pd impregnated on alumina powder with surface area of about 150 m²/g and beta-zeolite was mixed in, this mixture was then dried and calcined according to the preparation procedure discussed above to form the catalyst. The catalyst was shaped and tested as discussed above. The catalyst showed strong trapping properties at 50° C. When the catalyst temperature was ramped up to 500° C. in 20 K/min, some of the HC was released and measured as negative conversion. FIG. 3 shows results from the HC trap and release from 1% Pt/0.5% Pd on alumina with addition of beta-zeolite catalyst after 750° C. aging (12 hours/10% steamed air).

A summary of test results after powder aging in 10% steam/air at 750° C. of Comparative Examples 1-3 is provided in Table 1.

TABLE 1

| | Comparative | Comparative | Comparative |
|---|---|---|---|
| | Ex-1 | Ex-2 | Ex-3 |
| 1% Pt & 0.5% Pd on | | Spray Dried | 25% Alumina + |
| support | Alumina | Beta | 75% Beta |
| CO Light-Off Temp | 182 | 206 | 210 |
| ° C. @ 50% Conv | | | |
| HC Release @ Max | No trapping | 151 | 151 |
| Temp., ° C. | | | |
| Max % HC Release @ | No Release | −186 | −130 |
| Max Temp, ° C. | | | |
| HC Trapping | 0 | 48 | 60 |
| Conversion, % | | | |
| Max CO₂ (ppm) @ | 0 | 2900 at | 3000 at |
| (Temp., ° C.) | | 256° C. | 233° C. |

Accordingly, Comparative Examples 1-3 show that materials containing beta zeolite can trap HC species, but alumina alone does not exhibit HC trapping.

### Example 1

Core shell process: A series of core-shell supports was prepared as follows. Material for the shell structure was obtained in colloidal form, having a primary particle size distribution d₉₀ in the range of about 5 nm to about 1000 nm (1 μm). Material for the core structure was milled to a particle size distribution (PSD) at 90% (d₉₀) of less than 5 μm. The pH of the milled core material was adjusted to a level similar to the colloidal material for the shell structure. The milled core material and the colloidal shell material were mixed well for at least 1 hour. The final (PSD) at 90% (d₉₀) of the mixed material was <4-5 μm. The mixed material was then spray-dried to form the core-shell support. The spray-dried material was then calcined at 550° C. for 1 hour. 1% Pt & 0.5% Pd were impregnated onto the spray-dried material followed by drying and calcination as discussed above in the preparation procedure. Inventive Supports 1A-1F were prepared according to the following:
   1A: 15% Alumina shell wrapped 85% Beta Core;
   1B: 25% Alumina shell wrapped 45% Beta & 35% ZSM-5 Core;
   1C: 25% Alumina shell wrapped 75% ZSM-5 Core;
   1D: 10% Silica shell wrapped 90% Beta Core;
   1E: 15% CeO2 shell wrapped 85% Beta Core; and
   1F: 15% Alumina shell wrapped 50% Beta+CeO₂ Core.

Table 2 sets forth a summary of the ingredients of core-shell supports along with comparative supports. All of the supports were impregnated with 1% Pt and 0.5% Pd by weight of the support.

TABLE 2

| | | | H- | | | Colloidal | | |
|---|---|---|---|---|---|---|---|---|
| | Catalyst name | H-Beta % | ZSM-5 % | Al₂O₃ % | CeO₂ % | Al₂O₃ % | SiO2 % | CeO₂ % |
| Comparative | Alumina | 0 | 0 | 100 | 0 | 0 | 0 | 0 |
| Ex-1 | | | | | | | | |
| Comparative | Al₂O₃ + Beta | 75 | 0 | 25 | 0 | 0 | 0 | 0 |
| Ex-2 | | | | | | | | |
| Comparative | Beta (SD) | 100 | 0 | 0 | 0 | 0 | 0 | 0 |
| Ex-3 | | | | | | | | |
| Example 1A | Al₂O₃-15//Beta | 85 | 0 | 0 | 0 | 15 | 0 | 0 |
| Example 1B | Al₂O₃-20//(ZSM + | 45 | 35 | 0 | 0 | 20 | 0 | 0 |
| | Beta) | | | | | | | |
| Example 1C | Al₂O₃-25//ZSM | 0 | 75 | 0 | 0 | 25 | 0 | 0 |
| Example 1D | SiO₂-10//Beta | 90 | 0 | 0 | 0 | 0 | 10 | 0 |
| Example 1E | CeO₂-15//Beta | 85 | 0 | 0 | 0 | 0 | 0 | 15 |
| Example 1F | Al₂O₃- | 50 | 0 | 0 | 35 | 15 | 0 | 0 |
| | 15//(CeO₂ + Beta) | | | | | | | |

### Example 2

### Testing

A summary of test results after powder aging in 10% steam/air at 750° C. for 12 hours of Inventive Examples 1A-1F is provided in Tables 3.1 and 3.2.

TABLE 3.1

| | Example 1A | Example 1B | Example 1C |
|---|---|---|---|
| 1% Pt & 0.5% Pd on | Al₂O₃ 15% | Al₂O₃-20 | Al25%/ |
| support | | | ZSM-5 |
| | Coated Beta | (Beta + | |
| | | ZSM-5) | |
| Shell | 15% Alu- | 20% colloidal | 25% Al2O3 |
| | mina | Alumina | |
| Core | 85% Beta | 45% Beta + | 75% ZSM-5 |
| | zeolite | 35% ZSM-5 | |
| CO LO Temp ° C. @ 50% | 183 | 203 | 195 |
| Conv | | | |
| HC Release @ Max Temp., | 145 | 143 | No release |
| ° C. | | | |
| Max % HC Release @ Max | −82 | −40 | No release |
| Temp., ° C. | | | |
| HC Trapping Conversion, | 50-60 | 42 | |
| % | | | |
| % Max CO₂ Formation | 3650 at | 3000 at | 1800 at |
| (ppm) @ (Temp., ° C.) | 223° C. | 225° C. | 218° C. |

TABLE 3.2

| | Example 1D | Example 1E | Example 1F |
|---|---|---|---|
| 1% Pt & 0.5% Pd on | SiO₂-10// | CeO₂-15/ | Al/OSC/ |
| support | Beta | Beta | Beta -E-7 |
| Shell | 10% Col- | 15% CeO₂ | 15% Al₂O₃ |
| | loidal SiO₂ | | |
| Core | | | 50% Beta + |
| | | | 35% CeO₂ |
| CO LO Temp ° C. @ 50% | 196 | 205 | 194 |
| Conv | | | |
| HC Release @ Max Temp., | 148 | 150 | 137 |
| ° C. | | | |
| Max % HC Release @ Max | −121 | −139 | −107 |
| Temp., ° C. | | | |
| HC Trapping Conversion, | | 45 | 53 |
| % | | | |
| % Max CO₂ Formation | 3900 at | 600 at | 2840 at |
| (ppm) @ (Temp., ° C.) | 237° C. | 278° C. | 229° C. |

AS compared to the zeolite-containing comparative examples, the examples containing core-shell catalyst particles generally released less HC than spray-dried Beta zeolite and produced more CO₂, indicating high levels of HC converted.

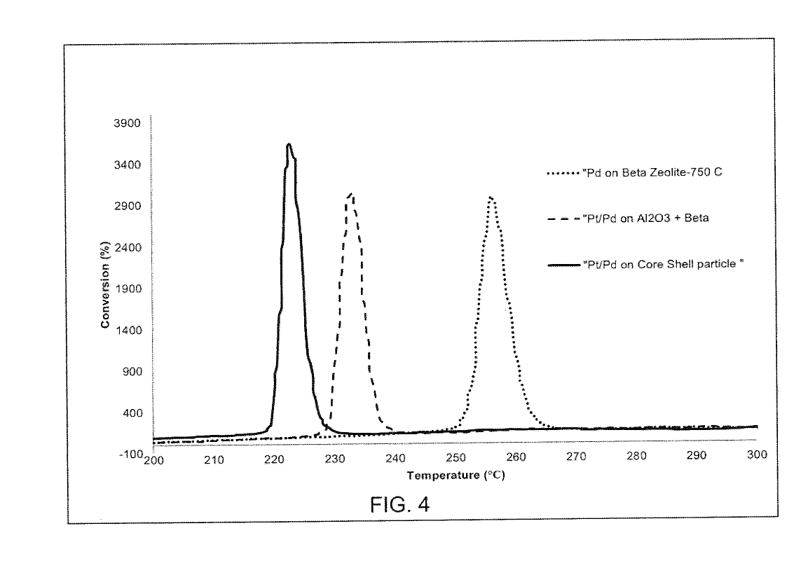

FIG. 4 provides a graph of formation (%) of CO₂ versus temperature (° C.) for the inventive material of Example 1A as compared to Comparative Examples 2-3 materials after aging at 750° C. (12 hours/10% steamed air). For Example 5A, the maximum CO₂ formation, which is an indication of HC trapping efficiency, of 3650% occurs at 223° C. For Comparative Examples 2-3, the maximum CO₂ formations (2900 and 3000, respectively) were lower at higher temperatures (256° C. and 233° C., respectively). Thus, the trapping efficiency of Example 1A was better than that of Comparative Examples 2-3.

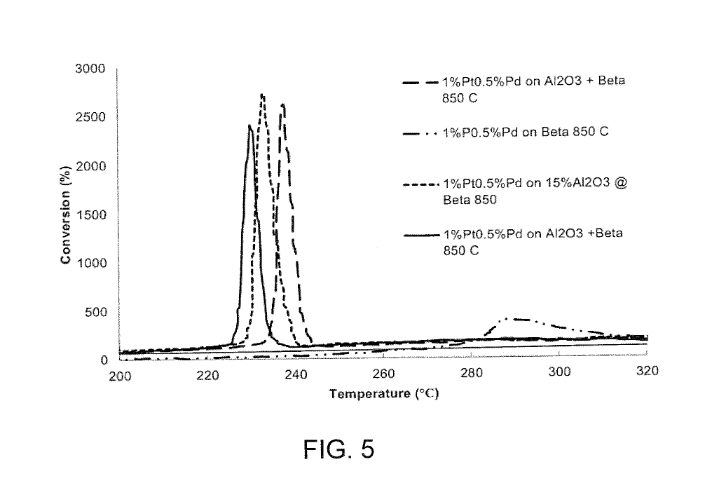

FIG. 5 provides a graph of formation (%) of CO₂ versus temperature (° C.) for the inventive material of Example 1A as compared to Comparative Examples 1-3 materials after aging at 850° C. (12 hours/10% steamed air). Comparative Example 1 provides no HC trapping efficiency due to the absence of a zeolite. The difference in HC trapping efficiency between Example 1A and Comparative Examples 2-3 is less pronounced after aging at 850° C. as compared to aging after 750° C.

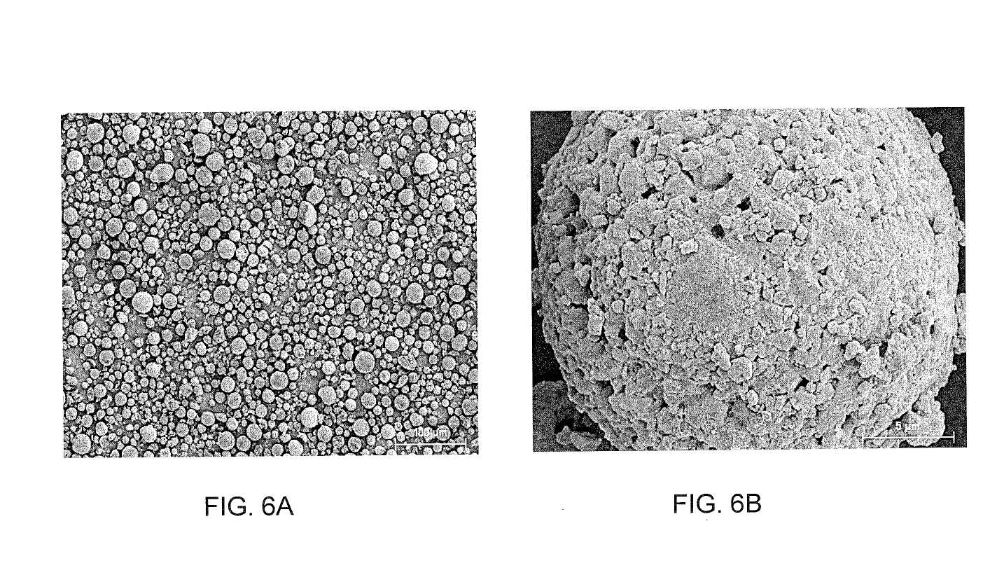

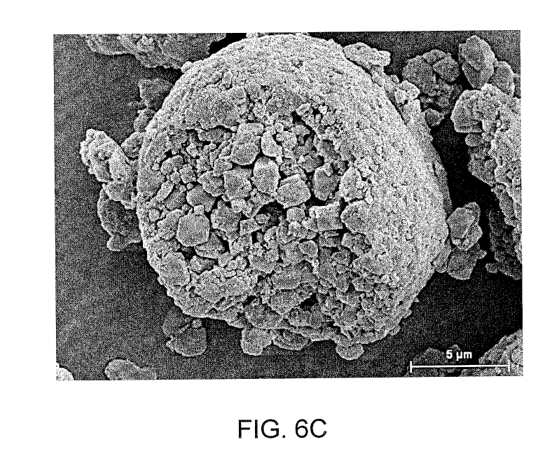

FIGS. 6A-6C are scanning electron microscope (SEM) photographs of the support of Example 1A having 15% alumina shell wrapping 85% beta-zeolite core. In FIG. 6A, a plurality of core-shell supports is shown under 200× magnification. FIG. 6B shows a 5000× magnification of an individual core-shell particle, the alumina shell enwrapping the beta-zeolite core and providing a substantially continuous coating around the core. FIG. 6C shows a 5000× magnification of a broken individual core-shell particle, where the core of beta-zeolite particles is shown as enwrapped by the alumina shell. The core is identifiable by the large particles and the shell is identifiable by the agglomeration of colloidal alumina particles.

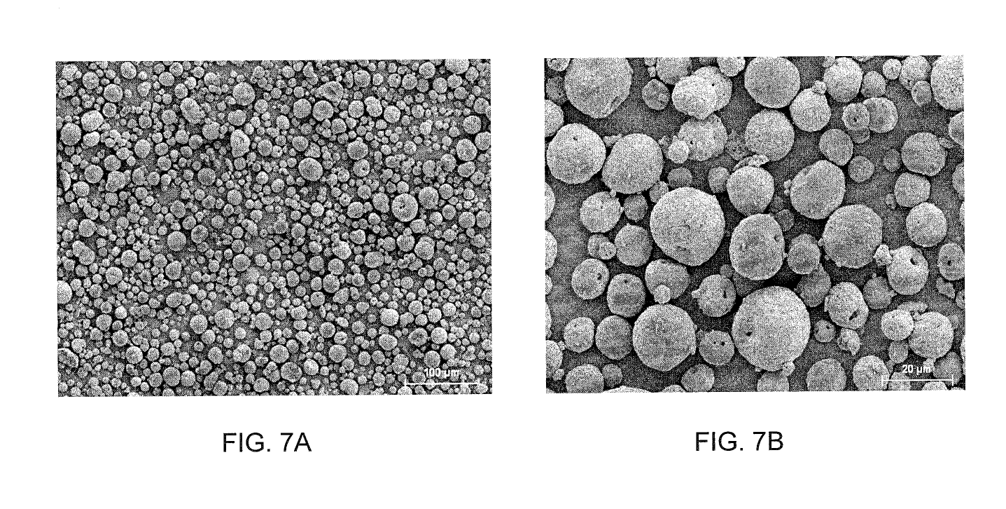

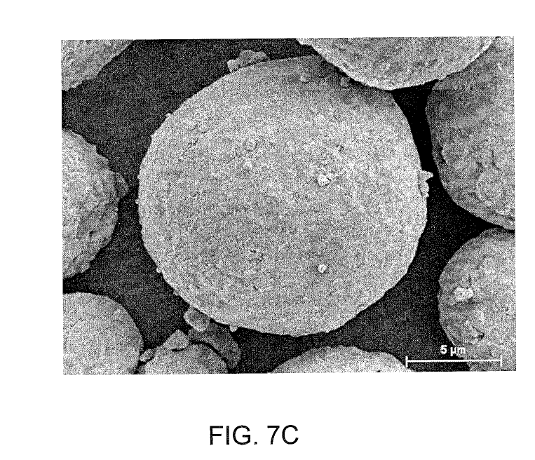

FIGS. 7A-7C are scanning electron microscope (SEM) photographs of a support having 25% alumina shell wrapping 75% beta-zeolite core. In FIG. 7A, a plurality of core-shell supports is shown under 200× magnification. FIG. 7B shows a 5000× magnification of an individual core-shell particle, the alumina shell enwrapping the beta-zeolite core and providing a continuous coating around the core. FIG. 7C shows a 5000× magnification of a broken individual core-shell particle, where the core of beta-zeolite is shown as enwrapped by the alumina shell. Again, the core is identifiable by the large particles and the shell is identifiable by the agglomeration of colloidal alumina particles.

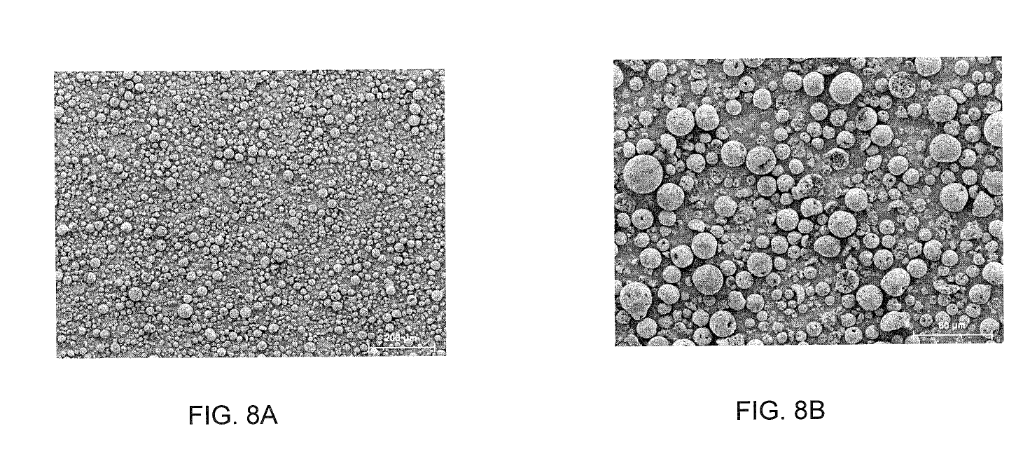

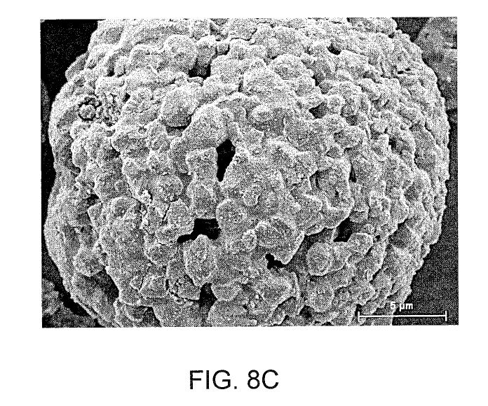

FIGS. 8A-8C are scanning electron microscope (SEM) photographs of a support of 20% alumina shell enwrapping a core: 45% beta-zeolite and 35% ZSM-5. In FIG. 8A, a plurality of core-shell supports is shown under 100× magnification. FIG. 8B shows a 1000× magnification of support core-shell particles, the alumina shell providing a substantially continuous coating around the core. FIG. 8C shows a 5000× magnification of an individual core-shell particle, where the core of beta-zeolite and ZSM-5 is shown as enwrapped by the alumina shell.

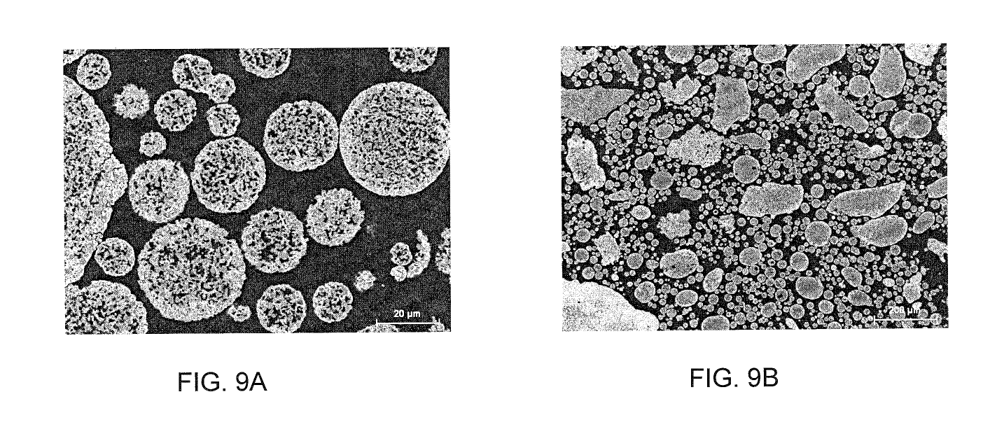

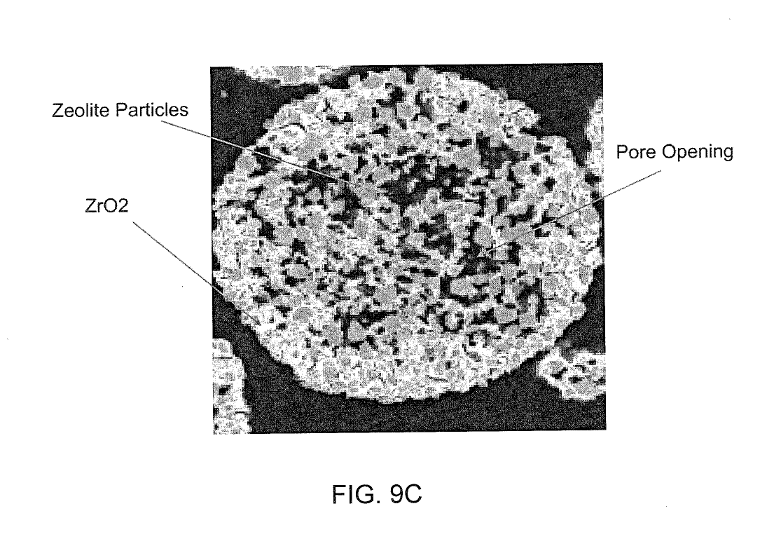

FIGS. 9A, 9B, and 9C are scanning electron microscope (SEM) photographs of a support of 25% zirconia wrapping a core of beta-zeolite under 5000× magnification. In FIG. 9C, the white images are the ZrO₂ enwrapping the zeolite, which is shown as grey areas. The black portion of the figure is the pores within the particle.

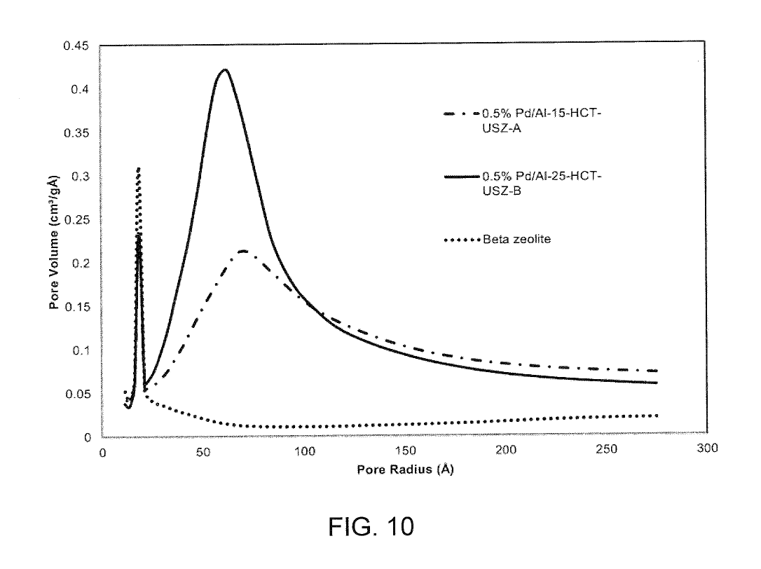

FIG. 10 is a dV/d log (r) graph of pore volume distribution versus pore radius (Å) for two inventive supports: Example 1A and a 25 wt. % alumina shell/75 wt. % beta-zeolite core (as depicted in FIGS. 7A-7C) and Comparative Example 2. The alumina shell enwrapping the zeolite particles shows an average pore radius of 50-60 Å. The highly porous structure of the core-shell particles allows for the facile diffusion of the reactants in and out of the particles.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

1. An automotive catalyst composite comprising:
a catalytic material on a carrier, the catalytic material comprising a plurality of core-shell support particles comprising a core and a shell surrounding the core,
wherein the core comprises a plurality of particles having a primary particle size distribution d₉₀ of up to about 5 μm, wherein the core particles comprise particles of one or more molecular sieves and optionally particles of one or more refractory metal oxides; and
wherein the shell comprises nanoparticles of one or more refractory metal oxides, wherein the nanoparticles have a primary particle size distribution d₉₀ in the range of about 5 nm to about 1000 nm (1 μm); and
optionally, one or more platinum group metals (PGMs) on the core-shell support;
wherein the catalytic material is effective to temporarily trap hydrocarbons in a vehicle exhaust stream and thereafter release the trapped hydrocarbons and convert the hydrocarbons to carbon oxides and water.

2. The automotive catalyst composite of claim 1, wherein the shell has a thickness in the range of about 1 to about 10 μm.

3. The automotive catalyst composite of claim 2, wherein the shell has a thickness in the range of about 2 to about 6 μm.

4. The automotive catalyst composite of claim 1, wherein the shell has a thickness of about 10 to about 50% of an average particle diameter of the core-shell support.

5. The automotive catalyst composite of claim 1, wherein the core has a diameter in the range of about 5 to about 20 μm.

6. The automotive catalyst composite of claim 1, wherein the core-shell support comprises about 50 to about 95% by weight of the core and about 5 to about 50% by weight of the shell, based on the total weight of the core-shell support.

7. The automotive catalyst composite of claim 1, wherein the core-shell support has an average particle diameter in the range of about 8 μm to about 30 μm.

8. The automotive catalyst composite of claim 1, wherein the core comprises particles of the molecular sieve having a primary particle size distribution d₉₀ in the range of about 0.1 to about 5 μm.

9. The automotive catalyst composite of claim 1, wherein the core comprises at least two molecular sieve types selected from the group consisting of small pore molecular sieve type, medium pore molecular sieve type, and large pore molecular sieve type.

10. The automotive catalyst composite of claim 1, wherein the refractory metal oxide of the shell is selected from the group consisting of alumina, zirconia-alumina, ceria, ceria-zirconia, zirconia, titania, silica, silica-alumina, manganese oxide, and combinations thereof.

11. The automotive catalyst composite of claim 10, wherein the shell further comprises a base metal oxide selected from the group consisting of lanthana, baria, strontium oxide, calcium oxide, magnesium oxide, and combinations thereof.

12. The automotive catalyst composite of claim 11, wherein the base metal oxide is present in an amount of about 1 to about 20% by weight, based on the weight of the core-shell support.

13. The automotive catalyst composite of claim 1, wherein the molecular sieve is selected from the group consisting of chabazite, ferrierite, clinoptilolite, silico-alumino-phosphate (SAPO), beta-zeolite, Y-zeolite, mordenite, ZSM-5, and combinations thereof.

14. The automotive catalyst composite of claim 1, wherein the molecular sieve is ion-exchanged with a metal selected from the group consisting of La, Ba, Sr, Mg, Pt, Pd, Ag, Cu Ni, Co, Fe, Zn, and combinations thereof.

15. The automotive catalyst composite of claim 1, wherein the core-shell support has an average pore radius greater than about 30 Å as measured by N₂ porosimetry.

16. The automotive catalyst composite of claim 1, wherein one or more PGMs is impregnated on the shell, the PGMs being selected from the group consisting of a Pt component, a Pd component, or combinations thereof.

17. The automotive catalyst composite of claim 16, wherein a weight ratio of Pt to Pd is in the range of about 5:1 to about 1:5.

18. The automotive catalyst composite of claim 16, wherein the total amount of Pt and Pd is about 0.1 to about 5% by weight, based on the total weight of the core-shell support.

19. The automotive catalyst composite of claim 1, wherein the carrier is a flow-through substrate or a wall-flow filter.

20. The automotive catalyst composite of claim 1, wherein the loading of the core-shell support particles on the carrier is about 0.5 to about 2.5 g/in³.

21. The automotive catalyst composite of claim 1, further comprising a refractory metal oxide binder.

22. The automotive catalyst composite of claim 1, further comprising a separate metal oxide component mixed with the core-shell support particles, the separate metal oxide component optionally impregnated with a PGM.

23. The automotive catalyst composite of claim 22, wherein the separate metal oxide component is selected from the group consisting of alumina, zirconia, and ceria, optionally impregnated with a Pt component, a Pd component, or a combination thereof.

24. The automotive catalyst composite of claim 1, further comprising a separate component mixed with the core-shell support particles, the separate component comprising mesoporous particles optionally impregnated with a PGM.

25. The automotive catalyst composite of claim 24, wherein the mesoporous particles comprise silica nanoparticles.

26. The automotive catalyst composite of claim 1, in the form of a single layer gasoline or diesel oxidation catalyst wherein the nanoparticles of the one or more refractory metal oxides of the shell are impregnated with a PGM.

27. The automotive catalyst composite of claim 1, in the form of a multi-layer gasoline Three Way Catalyst (TWC catalyst) comprising either (i) the core-shell support particles as a first layer and a second layer overlying the first layer comprising a refractory metal oxide and an oxygen storage component impregnated with a PGM; or (ii) the core-shell support particles as a first layer, a second layer of refractory metal oxide impregnated with PGM, overlying the first layer, and a third layer overlying the second layer comprising a mixture of refractory oxide and an oxygen storage component impregnated with a PGM.

28. The automotive catalyst composite of claim 27, wherein the PGM of the second layer or the third layer is selected from the group consisting of a Pd component, a Rh component, and combinations thereof.

29. The automotive catalyst composite of claim 1, wherein the catalytic material is zoned with a different catalytic material along a length of the carrier or wherein the catalytic material is layered with a different catalytic material on the carrier.

30. The automotive catalyst composite of claim 1, in a form effective as a catalyst to convert hydrocarbons (HC), carbon monoxide (CO), and NOx,
wherein the core comprises particles of one or more molecular sieves having a primary particle size distribution d₉₀ in the range of about 0.1 μm to about 5 μm and particles of one or more refractory metal oxides having a primary particle size distribution d₉₀ in the range of about 0.1 μm to about 5 μm;
wherein the shell comprises nanoparticles of one or more refractory metal oxides having a primary particle size distribution d₉₀ in the range of about 5 nm to about 100 nm (0.1 μm); and
further comprising one or more platinum group metals (PGMs) impregnated on the core-shell support;
wherein the core-shell support particles have an average pore radius greater than about 30 Å as measured by N₂ porosimetry.

31. An exhaust gas treatment system comprising the automotive catalyst composite of claim 1 located downstream of an internal combustion engine.

32. A method for treating an exhaust gas comprising hydrocarbons and carbon monoxide, the method comprising contacting the exhaust gas with the automotive catalyst composite of claim 1.

33. A method of making an automotive catalyst composite, the method comprising:
obtaining a plurality of particles in an aqueous suspension for a core structure, the particles having a primary particle size distribution d₉₀ of up to about 5 μm and comprising one or more molecular sieves;
obtaining a solution of nanoparticles of one or more refractory metal oxides having a primary particle size distribution d₉₀ in the range of about 5 nm to about 1000 nm (1 μm);
mixing the aqueous suspension for the core structure and the solution of nanoparticles to form a mixture;
spray-drying the mixture for form a plurality of core-shell support particles;
optionally impregnating the core-shell support particles with one or more platinum group metals (PGMs) to form a catalytic material; and
depositing the catalytic material on a carrier.

34. The method of claim 33, wherein the aqueous suspension for the core structure further comprises particles of one or more refractory metal oxides.

35. The method of claim 33, wherein one or more PGMs are impregnated on the core-shell support and are selected from the group consisting of platinum (Pt), rhodium (Rh), palladium (Pd), iridium (Jr), ruthenium (Ru), and combinations thereof.

36. A particulate material adapted for use as a coating on a catalyst article, comprising:
a plurality of core-shell support particles comprising a core and a shell surrounding the core,
wherein the core comprises a plurality of particles having a primary particle size distribution d₉₀ of up to about 5 μm, wherein the core particles comprise particles of one or more molecular sieves and optionally particles of one or more refractory metal oxides; and
wherein the shell comprises nanoparticles of one or more refractory metal oxides, wherein the nanoparticles have a primary particle size distribution d₉₀ in the range of about 5 nm to about 1000 nm (1 μm); and
optionally, one or more platinum group metals (PGMs) on the core-shell support, wherein the core-shell support particles are in dry form or in aqueous slurry form.
